(19) United States
(12) Patent Application Publication
(10) Pub. No.: US 2024/0221105 A1
(43) Pub. Date: Jul. 4, 2024

(54) INFORMATION PROVIDING METHOD AND COMPUTER PROGRAM PRODUCE FOR INFORMATION DISPLAY

(71) Applicant: Panasonic Automotive Systems Co., Ltd., Kanagawa (JP)

(72) Inventors: Akihiko IGUCHI, Osaka Fu (JP); Fumio KOSUGE, Kanagawa Ken (JP); Hideyuki TAKAHASHI, Kanagawa Ken (JP)

(73) Assignee: Panasonic Automotive Systems Co., Ltd., Kanagawa (JP)

(21) Appl. No.: 18/606,992

(22) Filed: Mar. 15, 2024

Related U.S. Application Data
(63) Continuation of application No. PCT/JP2022/020732, filed on May 18, 2022.

(30) Foreign Application Priority Data
Sep. 21, 2021 (JP) 2021-153560

(51) Int. Cl. G06Q 50/40

(52) U.S. Cl. CPC G06Q 50/40

(57) ABSTRACT

An information providing method according to the present disclosure is an information providing method in a parking lot management system that communicates with display terminals of users and manages vehicle image information including images of vehicles parked in parking sections of a parking lot, and includes: acquiring from the vehicle image information, when a request from a display terminal of a user among the users is accepted, vehicle image information associated with user information registered by the user; and specifying a parking position of a vehicle of the user based on the acquired vehicle image information to cause the display terminal of the user to display an image of the vehicle of the user and the parking position of the vehicle.

### CROSS-REFERENCE TO RELATED APPLICATIONS

This application is a continuation of International Application No. PCT/JP2022/020732, filed on May 18, 2022 which claims the benefit of priority of the prior Japanese Patent Application No. 2021-153560, filed on Sep. 21, 2021, the entire contents of which are incorporated herein by reference.

### FIELD

Embodiments described herein relate generally to an information providing method and a computer program produce for information display.

### BACKGROUND

Conventionally, there is a service of, when parking in a large parking lot of a large commercial facility etc., recognizing and estimating an attribute and a type of a user from image information of the user and a vehicle imaged in the parking lot, and storing and monitoring a baggage or the like of the user (see, for example, Japanese Patent No. 6305483). There is a service in which, when a vehicle used by a user is parked in a parking lot, the user searches for the vehicle by himself/herself from an image captured in the parking lot at the time of exiting the parking lot, specifies the vehicle, and then performs parking fare settlement (see, for example, JP 2020-144654 A).

However, in a captured image captured in a parking lot, it is necessary to use image information of entering and exiting and to estimate a specific user from the captured image, and further improvement of a service provided in the parking lot is required.

The present disclosure provides an information providing method and a computer program produce for information display capable of checking a state of a vehicle according to an operation of a user from information provided by the user and a captured image captured in a parking lot.

### SUMMARY

An information providing method according to an embodiment of the present disclosure in a parking lot management system that communicates with display terminals of users and manages vehicle image information including images of vehicles parked in parking sections of a parking lot, includes: when a request, from a display terminal of a user among the users, for an image of a vehicle of the user and a parking position of the vehicle is accepted, acquiring, from the vehicle image information, vehicle image information associated with user information registered by the user; and specifying the parking position of the vehicle based on the acquired vehicle image information to cause the display terminal of the user to display the image of the vehicle of the user and the parking position of the vehicle.

### BRIEF DESCRIPTION OF THE DRAWINGS

FIG. 1 is a diagram illustrating an example of a configuration of an information providing system according to an embodiment;

FIG. 2 is a diagram illustrating an example of functional blocks of the information providing system according to the embodiment;

FIG. 3 is a diagram illustrating an example of a display form of an in-parking lot vehicle monitor according to the embodiment;

FIG. 4 is a diagram illustrating an example of a display form of user registration according to the embodiment;

FIG. 5 is a diagram illustrating an example of a display form of a parking contact according to the embodiment;

FIG. 6 is a diagram illustrating an example of a display form of monitoring according to the embodiment;

FIG. 7 is a diagram illustrating an example of a display form of monitoring according to the embodiment;

FIG. 8 is a diagram illustrating an example of a display form of monitoring according to the embodiment;

FIG. 9 is a diagram illustrating an example of a display form of a notification request according to the embodiment;

FIG. 10 is a diagram illustrating an example of a display mode of a notification according to the embodiment;

FIG. 11 is a sequence diagram illustrating an example of a procedure of processing executed in the information providing system according to the embodiment;

FIG. 12 is a sequence diagram illustrating an example of a procedure of processing executed in the information providing system according to the embodiment;

FIG. 13 is a diagram illustrating an example of functional blocks of an information providing system according to a modification example; and

FIG. 14 is a sequence diagram illustrating an example of a procedure of processing executed in an information providing system according to the modification example.

### DETAILED DESCRIPTION

Hereinafter, embodiments of an information providing method and a computer program produce for information display according to the present disclosure will be described with reference to the accompanying drawings.

### Configuration of Information Providing System 10

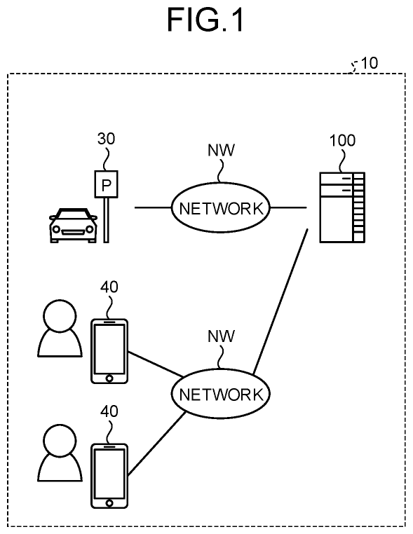

FIG. 1 is a schematic diagram illustrating an example of an information providing system 10 according to an embodiment. The information providing system 10 includes a parking lot 30, a display terminal 40, and a parking lot management system 100. The parking lot 30, the display terminal 40, and the parking lot management system 100 communicate with each other via a communication network NW. The communication network NW is a mobile phone network having a large number of base stations as terminals, a satellite communication network using communication satellites, or the like.

As illustrated in FIG. 1, the information providing system 10 communicates with the display terminals 40 of users and manages vehicle image information including images of vehicles parked in parking sections in the parking lot 30. When accepting a request from the display terminal 40 of the user, the information providing system 10 acquires vehicle image information associated with user information registered by the user from the vehicle image information, and specifies a parking position of the vehicle on the basis of the acquired vehicle image information, thereby displaying the image of the vehicle of the user and the parking position of the vehicle on the display terminal 40 of the user.

Note that the vehicle associated with the user information is, for example, a vehicle owned by the user, but is not limited thereto. For example, the user may register a vehicle that the user rides, such as a vehicle of a family member or a friend, or may register a vehicle that is temporarily or intermittently used by using a rental car, car sharing, or the like.

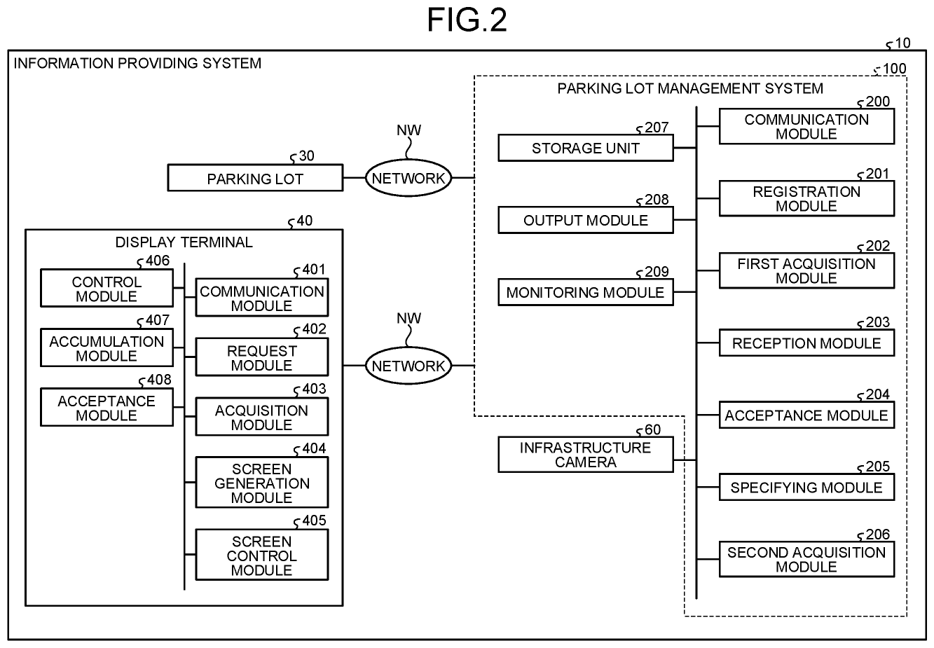

Next, each function of the information providing system 10 according to the embodiment will be described with reference to FIG. 2. FIG. 2 is a diagram illustrating an example of functional blocks of the information providing system 10 according to the embodiment.

### Configuration of Display Terminal 40

The display terminal 40 displays vehicle image information and parking position information of a vehicle owned by a user and parked in a parking section. The display terminal 40 is an example of an information display device. In the present embodiment, a portable information terminal such as a smartphone or a tablet PC will be described as an example of the display terminal 40.

The display terminal 40 has functions as a communication module 401, a request module 402, an acquisition module 403, a screen generation module 404, a screen control module 405, a control module 406, an accumulation module 407, and an acceptance module 408.

The communication module 401 transmits and receives information to and from the parking lot management system 100. For example, the communication module 401 transmits information input to the display terminal 40 to the parking lot management system 100 via a known communication line such as a mobile phone network. The communication module 401 receives, from the parking lot management system 100, parked vehicle information in which the user information, the vehicle information, the vehicle image information, and the parking position information are associated with each other, and the vehicle image information and the parking position information included in the parked vehicle information via a known communication line such as a mobile phone network.

The request module 402 requests a request including at least the user information to the parking lot management system 100. The request module 402 requests information regarding the parked vehicle that is parked in the parking lot 30 the parking lot management system 100.

The acquisition module 403 acquires the parked vehicle information requested by the request module 402 from the parking lot management system 100. As an example, the acquisition module 403 does not acquire information already stored in the accumulation module 407 from the parking lot management system 100. When acquiring the parking lot information from the parking lot management system 100, the acquisition module 403 may acquire information including the information already stored in the accumulation module 407.

The screen generation module 404 generates an image to be displayed on a display device of the display terminal 40.

The screen control module 405 outputs the image generated by the screen generation module 404 to the display device of the display terminal 40. In other words, the screen control module 405 causes the display device of the display terminal 40 to display the image to the user. For example, the screen control module 405 displays the parked vehicle information and the like as an image.

The control module 406 controls the communication module 401, the request module 402, the acquisition module 403, the screen generation module 404, the screen control module 405, the accumulation module 407, and the acceptance module 408 on the basis of the information acquired by the display terminal 40.

The accumulation module 407 accumulates the information acquired by the display terminal 40. The accumulation module 407 accumulates, for example, the parked vehicle information.

The acceptance module 408 accepts an input of an instruction or information from the user.

The information display program is provided as an application program executed in the display terminal 40. The information display program is executed in a computer of the display terminal 40 including a display connectable to the parking lot management system 100 that manages the vehicle image information including the images of the vehicles parked in the parking sections in the parking lot 30 via a network.

The information display program requests the parking lot management system 100 to transmit the vehicle image information associated with the user information of the user who owns the display terminal 40 and the parking position of the vehicle of the user, and displays the image of the vehicle of the user and the parking position of the vehicle included in the vehicle image information received from the parking lot management system on the display of the display terminal. Here, the operation of displaying is executed at a predetermined timing when the user requests the parked vehicle information. The parked vehicle information is determined according to the fact that a vehicle that matches the vehicle information associated with the user who owns the display terminal 40 is parked in the parking section.

### Configuration of Infrastructure Camera 60

An infrastructure camera 60 is a sensor that observes the inside of the parking lot. The infrastructure camera 60 images, for example, a parking section and a vehicle path in the parking lot, and acquires parking lot image data. The infrastructure camera 60 is a digital camera, a stereo camera, or the like. The parking lot image data is digital image data in which a pixel value is defined for each pixel. An installation position and an angle of view of the infrastructure camera 60 are adjusted in advance so that the inside of the parking lot can be imaged. In the present embodiment, a plurality of infrastructure cameras 60 having different imaging directions are provided in the parking lot. A management number is assigned to the infrastructure camera 60.

### Configuration of Parking Lot Management System 100

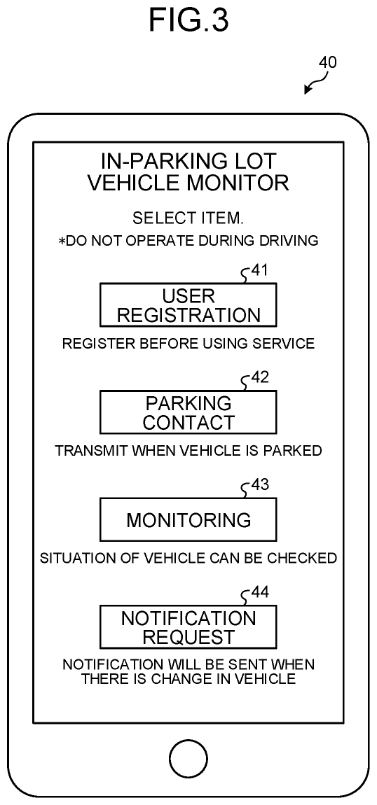

The parking lot management system 100 is a system that outputs a captured image acquired from the infrastructure camera 60 that images the inside of the parking lot 30 to the display terminal 40 operated by the user. Specifically, the parking lot management system 100 outputs an in-parking lot vehicle monitor indicating vehicle monitoring in the parking lot illustrated in FIG. 3. The in-parking lot vehicle monitor includes, for example, user registration 41, a parking contact 42, monitoring 43, and a notification request 44. Details thereof will be described later.

The parking lot management system 100 includes a communication module 200, a registration module 201, a first acquisition module 202, a reception module 203, an acceptance module 204, a specifying module 205, a second acquisition module 206, a storage unit 207, an output module 208, and a monitoring module 209. A function of the parking lot management system 100 is not limited thereto. The above-described functions may be realized by different systems.

The communication module 200 transmits and receives information to and from the display terminal 40. For example, the communication module 200 receives user information indicating information regarding the user and vehicle information indicating information regarding the vehicle from the display terminal 40 via a known communication line such as a mobile phone network. The communication module 200 transmits the parked vehicle information in which the user information, the vehicle information, the vehicle image information, and the parking position information are associated with each other, the vehicle image information and the parking position information included in the parked vehicle information, to the display terminal 40 via a known communication line such as a mobile phone network.

The registration module 201 registers the user information indicating the information regarding the user and the vehicle information indicating the information regarding the vehicle. Specifically, the registration module 201 registers the user information indicating the information regarding the user and the vehicle information indicating the information regarding the vehicle used by the user on the basis of the information input from the display terminal 40 owned by the user.

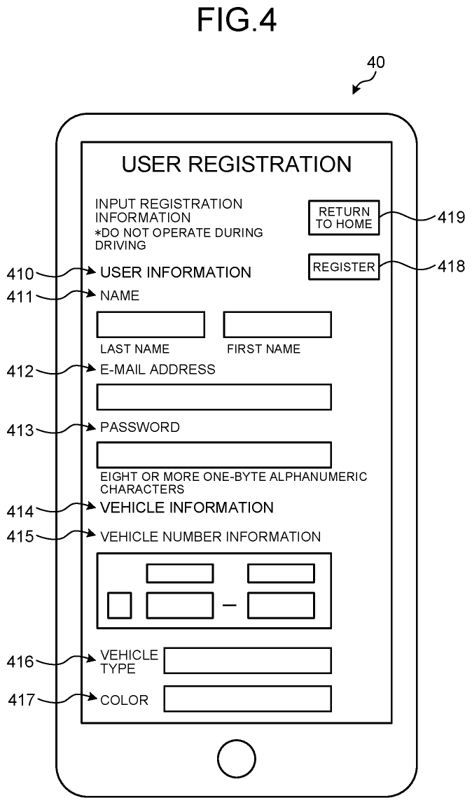

Here, user information and vehicle information registered by the registration module 201 will be described with reference to FIGS. 3 and 4. FIG. 3 is an example of a home screen of the in-parking lot vehicle monitor provided by the parking lot management system 100 according to the present embodiment. FIG. 4 is an example of registration information in a case where provision of the in-parking lot vehicle monitor is received. First, when receiving the provision of the in-parking lot vehicle monitor, the user performs the user registration 41. When the user presses the user registration 41 displayed on the display terminal 40, a transition to display content illustrated in FIG. 4 occurs.

When the user receives provision of the in-parking lot vehicle monitor, the user registers user information 410 and vehicle information 414. Specifically, the user information 410 includes a name 411 indicating the name of the user, an e-mail address 412 indicating a contact address of the user, and a password 413 indicating authentication necessary for identifying the user. The vehicle information 414 includes vehicle number information 415 indicating information for specifying the vehicle, a vehicle type 416 indicating the type of the vehicle, and a color 417 indicating a color of the vehicle. After inputting the user information 410 and the vehicle information 414 displayed on the display terminal 40, the user presses registration 418. The communication module 401 of the display terminal 40 transmits the information input by the user to the parking lot management system 100. The registration module 201 registers the identification information transmitted from the display terminal 40 in the storage unit 207.

In a case where the user desires to perform a transition to the content displayed in FIG. 3, for example, the user presses return to home 419. Note that a contact address of the user is not limited to the e-mail address 412, and may be a mobile number of the user. Note that the vehicle information 414 is not limited to the vehicle number information 415, the vehicle type 416, and the color 417. Not all pieces of the vehicle information 414 input by the user may be registered. That is, the vehicle information 414 may be any information that specifies the vehicle used by the user. When the user registers the user information 410 and the vehicle information 414, the parking lot management system 100 can ascertain the vehicle used by the user.

FIG. 2 will be referred to again. The first acquisition module 202 acquires vehicle image information including an image of the vehicle parked in the parking lot. Specifically, the first acquisition module 202 acquires the vehicle image captured by the infrastructure camera 60 and a management number of the infrastructure camera 60 from the infrastructure camera 60. The vehicle image information includes vehicle information 414 indicating information regarding the vehicle, an image of an adjacent vehicle indicating another vehicle adjacent to the vehicle, a parking section position where the vehicle is parked, and imaging device information indicating an imaging device that images the parking section position. The imaging device information is a management number of the infrastructure camera 60.

The reception module 203 receives parking contact information indicating that the vehicle has been parked from the display terminal 40. Specifically, when the user parks the vehicle in the parking section of the parking lot, the user inputs parking contact information indicating that the vehicle has been parked to the display terminal 40, and the reception module 203 receives the parking contact information transmitted by the communication module 401 of the display terminal 40. Thereafter, the reception module 203 stores the parking contact information in the storage unit 207.

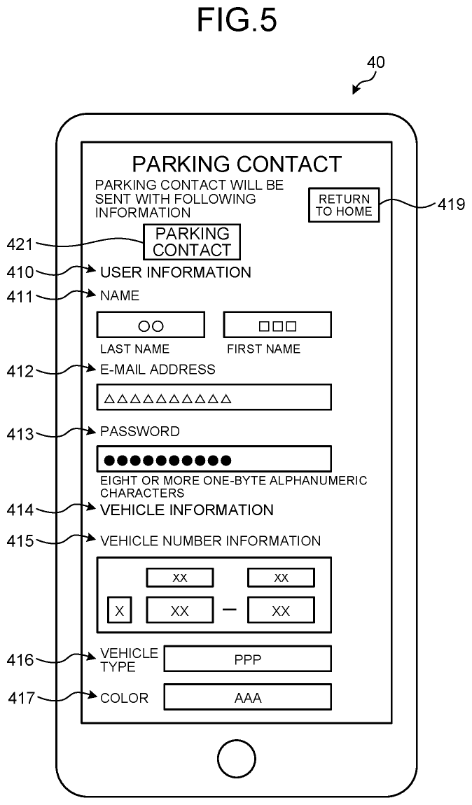

Here, the parking contact information will be described with reference to FIGS. 3 and 5. FIG. 5 illustrates an example of parking contact information provided by the in-parking lot vehicle monitor. First, when parking of the vehicle is completed, the user performs the parking contact 42. When the user presses the parking contact 42 displayed on the display terminal 40, a transition to the display content illustrated in FIG. 5 occurs.

The user checks the content of the user information 410 and the vehicle information 414 registered in advance as the parking contact information, and presses the parking contact 421 displayed on the display terminal 40 when the registered user information 410 and the registered vehicle information 414 match. The reception module 203 receives the parking contact information transmitted from the communication module 401 of the display terminal 40, and stores the parking contact information in the storage unit 207. The parking lot management system 100 can ascertain that the user has parked the vehicle by the user performing the parking contact.

The acceptance module 204 accepts a request including at least the user information 410 from the display terminal 40. Specifically, in a case where the acceptance module 204 checks a state of the vehicle used by the user, the user inputs a request for checking the state of the vehicle to the display terminal 40, and transmits the request from the communication module 401. The acceptance module 204 stores the received request in the storage unit 207.

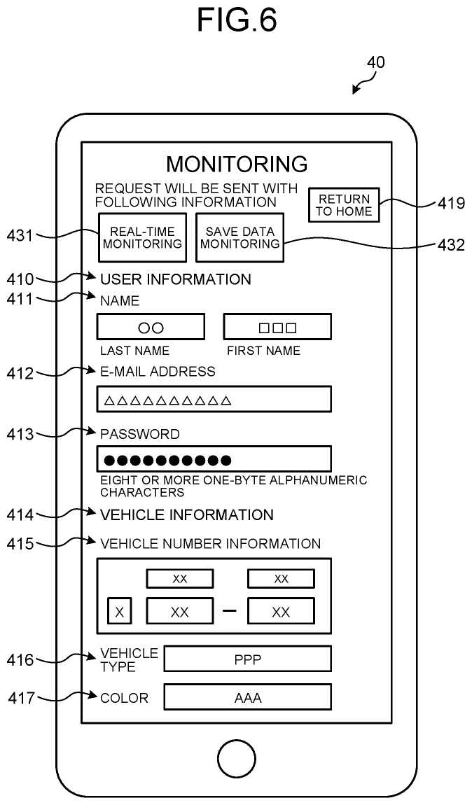

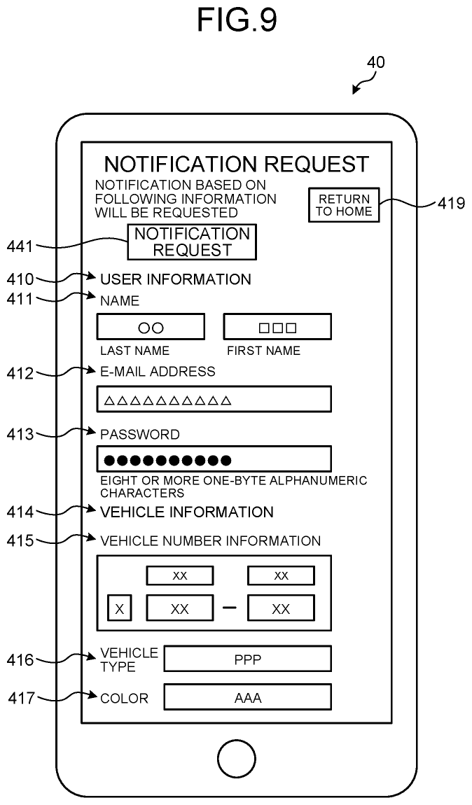

Here, content requested by the user will be described with reference to FIGS. 3, 6, and 9. FIG. 6 illustrates an example of monitoring provided by the in-parking lot vehicle monitor. FIG. 9 illustrates an example of the notification request 44 provided by the in-parking lot vehicle monitor.

When checking the state of the vehicle, the user presses monitoring 43 illustrated in FIG. 3. When the user presses the monitoring 43, a transition to the display content illustrated in FIG. 6 occurs. When checking the current state of the vehicle, the user checks the content of the user information 410 and the vehicle information 414 registered in advance, and presses real-time monitoring 431. When checking a state of the vehicle including the past time, the user checks the content of the identification information registered in advance, and presses save data monitoring 432. The request module 402 of the display terminal 40 requests the parked vehicle information to the parking lot management system 100 on the basis of the button pressed by the user.

When monitoring a state of the vehicle, the user presses the notification request 44 illustrated in FIG. 3. When the user presses the notification request 44, a transition to the display content illustrated in FIG. 9 occurs. The user checks the content of the user information 410 and the vehicle information 414 registered in advance, and presses a notification request 441. The request module 402 of the display terminal 40 makes a request to the parking lot management system 100 on the basis of the button pressed by the user. As a result, the acceptance module 204 can accept the request of the user with the request module 402 of the display terminal 40. Note that either the user information 410 or the vehicle information 414 to be checked by the user may be checked.

FIG. 2 will be referred to again. The specifying module 205 specifies parked vehicle information including the user information 410 included in the request accepted by the acceptance module 204 from among the one or more pieces of parked vehicle information stored in the storage unit 207. Here, one or more pieces of parked vehicle information stored in the storage unit 207 will be described.

The storage unit 207 stores, for each user, parked vehicle information in which the user information 410 indicating information regarding the user, the vehicle information 414 indicating information regarding a vehicle, vehicle image information including an image of the vehicle, and parking position information indicating a position where the vehicle is parked are associated. The user information 410 and the vehicle information 414 are information stored in the storage unit 207 by the registration module 201 described above. The vehicle image information is information stored in the storage unit 207 by the first acquisition module 202.

The specifying module 205 specifies a vehicle from the vehicle information 414 included in the vehicle image information stored in the storage unit 207. The specifying module 205 specifies parking position information from the parking position information included in the vehicle image information stored in the storage unit 207. The specifying module 205 stores the specified vehicle and parking position information in the storage unit 207. As a result, the storage unit 207 stores, for each user, parked vehicle information in which the stored user information 410, vehicle information 414, vehicle image information, and parking position information are associated with each other.

The description returns to the specifying module 205. The specifying module 205 specifies parked vehicle information including the user information 410 and the vehicle information 414 accepted by the acceptance module 204 from among the pieces of parked vehicle information stored in the storage unit 207. The specifying module 205 specifies, from the specified parked vehicle information, a vehicle used by the user from whom the request has been accepted and parking position information.

Note that, in the present embodiment, the parking lot management system 100 ascertains that the vehicle has been parked when the above reception module 203 receives the parking contact transmitted by the display terminal 40, but may estimate that the vehicle has been parked at the time at which the specifying module 205 specifies the vehicle. The specifying module 205 may use only the vehicle number information 415 as the vehicle information 414 for specifying the vehicle or may use a combination of the vehicle type 416 and the color 417, and the present disclosure is not limited thereto.

The second acquisition module 206 acquires vehicle image information including the vehicle specified by the specifying module 205. Specifically, the second acquisition module 206 acquires a vehicle image captured by the infrastructure camera 60 at a predetermined cycle. The vehicle image information includes, for example, a vehicle and another vehicle adjacent to the vehicle. The vehicle image information includes, for example, images of a front surface indicating a front portion of the vehicle and a back surface indicating a rear portion of the vehicle. The vehicle image information may include a sign indicating a parking section or a parking position of the vehicle.

The second acquisition module 206 stores the vehicle image information in the storage unit 207. The storage unit 207 stores the vehicle image information in association with the parked vehicle information for each time at which the vehicle image information acquired by the second acquisition module 206 is stored.

In the present embodiment, in the parking lot management system 100, the second acquisition module 206 described above acquires the vehicle image information including the vehicle specified by the specifying module 205, but the first acquisition module 202 may have the function of the second acquisition module 206.

The output module 208 outputs the vehicle image information and the parking position information included in the parked vehicle information specified by the specifying module 205. Specifically, the output module 208 outputs the vehicle image information and the parking position information to the user from whom the request has been accepted. Thereafter, the communication module 200 transmits the output vehicle image information and parking position information to the display terminal 40.

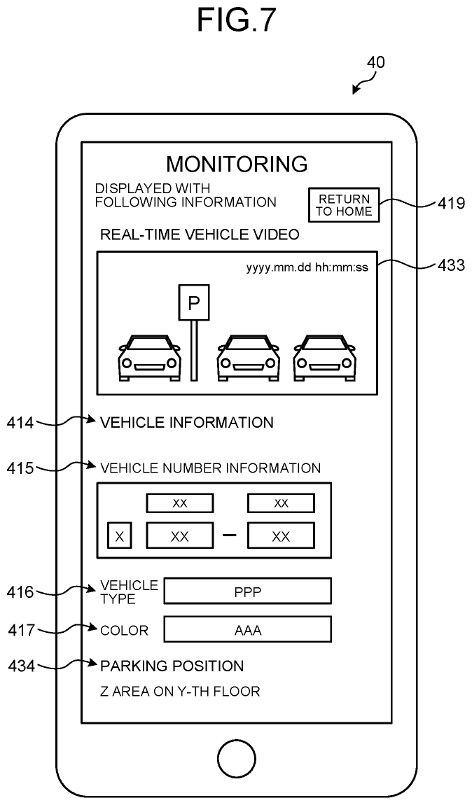

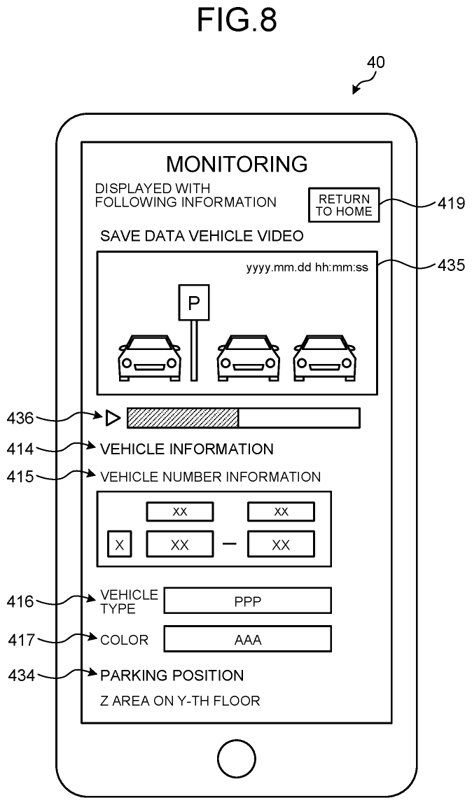

Here, content output by the output module 208 will be described with reference to FIGS. 7 and 8. FIGS. 7 and 8 illustrate examples of vehicle image information provided by the in-parking lot vehicle monitor.

When the user presses the real-time monitoring 431 illustrated in FIG. 6, a transition to the display content illustrated in FIG. 7 occurs. A real-time vehicle video 433 indicating the vehicle image information output by the output module 208 in the real-time monitoring 431 includes a time included in the real-time vehicle video 433 captured by the infrastructure camera 60, the vehicle used by the user, and a vehicle adjacent to the vehicle used by the user.

The output module 208 outputs the vehicle number information 415, the vehicle type 416, the color 417 registered by the user, and a parking position 434 specified by the specifying module 205. The output module 208 outputs the vehicle image information, so that the user can ascertain the state of the vehicle and the position where the vehicle is parked.

When the user presses the save data monitoring 432 illustrated in FIG. 6, a transition to the display content illustrated in FIG. 8 occurs. A save data vehicle video 435 indicating the vehicle image information output by the output module 208 through the save data monitoring 432 includes a time included in the save data vehicle video 435 captured by the infrastructure camera 60, the vehicle used by the user, and a vehicle adjacent to the vehicle used by the user.

The output module 208 outputs the vehicle number information 415, the vehicle type 416, the color 417 registered by the user, and the parking position 434 specified by the specifying module 205.

In the display content illustrated in FIG. 8, a reproduction position function 436 for reproducing a portion corresponding to a time designated by the user is displayed. Here, a seek bar is provided as an example of the reproduction position function 436. The reproduction position function 436 is not limited to a seek bar, and includes a function that can reproduce a reproduction position on the basis of a time input by the user. Since a portion corresponding to the time designated by the user is linked with the save data of the vehicle image information stored in the parking lot management system 100 by providing the reproduction position function 436, it is possible to ascertain a state of the vehicle without taking time and effort of the user.

By providing the reproduction position function 436, for example, in a case where a trouble occurs in the parking lot, the user can specify the time when an image is captured, and can ascertain a situation at the time of occurrence of the trouble. When the user sets a parking time by using the reproduction position function 436, the user can check whether the vehicle has been locked. For example, the user can ascertain that the vehicle has been locked by checking an answer back indicating that the vehicle has been locked, such as when side mirrors are folded and a hazard lamp is still turned on.

The output module 208 outputs the vehicle image information when there is a temporal change in the vehicle image information. Specifically, when the monitoring module 209 determines that there is a temporal change in the vehicle image information, the output module 208 outputs the vehicle image information having a temporal change. Details of the monitoring module 209 will be described later.

Note that, as the vehicle image information output by the output module 208, only the vehicle used by the user may be extracted, and the peripheral image other than the vehicle may be masked. Alternatively, only the vehicle numbers of adjacent vehicles may be masked. The mask processing makes it easier for the user to ascertain the vehicle to be used. Specification of the user information can be considered for other users.

FIG. 2 will be referred to again. The monitoring module 209 monitors whether there is a temporal change in the vehicle image information acquired by the second acquisition module 206. Specifically, in a case where the monitoring module 209 monitors a state of the vehicle used by the user, the user inputs information indicating that the state of the vehicle is being monitored to the display terminal 40, and the communication module 401 of the display terminal 40 transmits the information. Thereafter, the monitoring module 209 starts monitoring a state of the vehicle in accordance with the content transmitted by the display terminal 40. In a case where it is determined that there is a temporal change in the state of the vehicle, the monitoring module 209 transmits the determination result to the output module 208, and the output module 208 outputs vehicle image information having a temporal change.

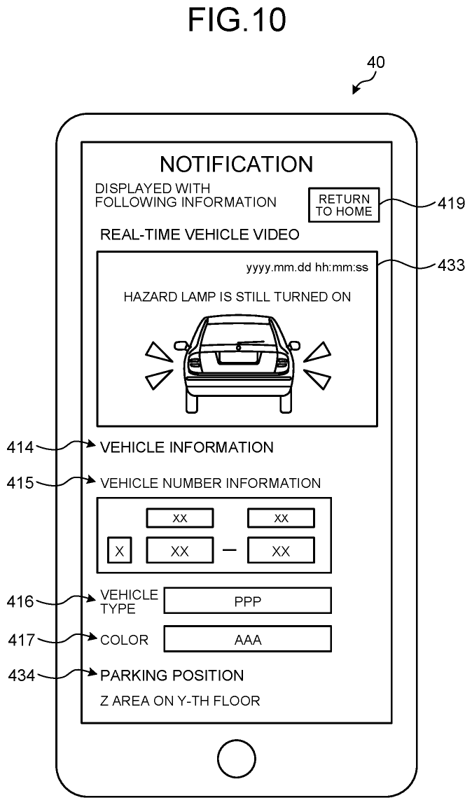

Here, vehicle image information having a temporal change will be described with reference to FIG. 10. FIG. 10 illustrates an example of vehicle image information provided by the in-parking lot vehicle monitor.

Upon receiving a notification request 441 illustrated in FIG. 9 from the display terminal 40, the monitoring module 209 monitors a state of the vehicle used by the user. Specifically, the monitoring module 209 monitors whether or not there is a temporal change in the vehicle image information acquired by the second acquisition module 206. When it is determined that there is a temporal change in the vehicle image information, the monitoring module 209 transmits the determination result to the output module 208.

The state of the vehicle having a temporal change is, for example, forgetting to turn off the hazard lamp. In FIG. 10, the output module 208 outputs a real-time vehicle video 433 indicating the vehicle image information having a temporal change.

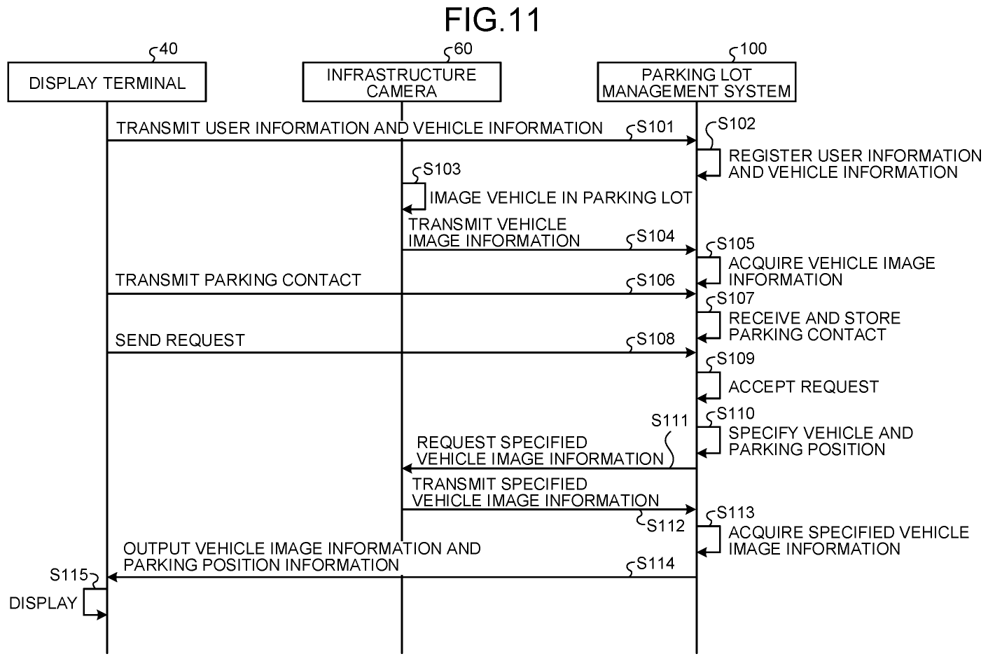

Next, a procedure of processing executed in the information providing system 10 will be described below with reference to FIG. 11. FIG. 11 is a sequence diagram illustrating an example of a procedure of processing executed in the information providing system 10 according to the present embodiment.

The communication module 401 transmits the user information 410 and the vehicle information 414 input by the user through the user registration 41 to the parking lot management system 100 (Step S101). The registration module 201 registers the user information 410 and the vehicle information 414 transmitted from the display terminal 40 in Step S101 (Step S102).

The infrastructure camera 60 images a vehicle in the parking lot (Step S103). The infrastructure camera 60 transmits the vehicle image information captured in Step S103 to the parking lot management system 100 (Step S104). The first acquisition module 202 acquires the vehicle image information captured by the infrastructure camera 60 (Step S105).

The first acquisition module 202 acquires parking position information indicating a position where the vehicle is parked from the captured image. Note that the infrastructure camera 60 may transmit the captured image to the parking lot management system 100 immediately after capturing the image, or may transmit the captured image to the parking lot management system 100 at predetermined intervals, and a transmission timing is not limited thereto.

The communication module 401 transmits the parking contact 421 input by the user to the parking lot management system 100 (Step S106). In the parking lot management system 100, the reception module 203 receives the parking contact 421 transmitted from the display terminal 40 (Step S107). The reception module 203 stores the parking contact 42 in the storage unit 207.

The request module 402 sends a request including at least the user information 410 (Step S108). The acceptance module 204 accepts the request including at least the user information 410 from the display terminal 40 (Step S109). Thereafter, the specifying module 205 specifies parked vehicle information including the user information 410 and the vehicle information 414 accepted by the acceptance module 204 from the pieces of parked vehicle information stored in the storage unit 207. The specifying module 205 specifies, from the specified parked vehicle information, the vehicle used by the user from whom the request has been accepted and the parking position information (Step S110).

The second acquisition module 206 requests vehicle image information including the vehicle specified by the specifying module 205 to the infrastructure camera 60 (Step S111). The infrastructure camera 60 transmits the vehicle image information to the parking lot management system 100 on the basis of the request from the second acquisition module 206 (Step S112). The second acquisition module 206 acquires the vehicle image information transmitted by the infrastructure camera 60 (Step S113).

The output module 208 outputs the vehicle image information and the parking position information included in the parked vehicle information specified by the specifying module 205 to the display terminal 40 (Step S114). The acquisition module 403 acquires the vehicle image information and the parking position information output from the output module 208. The screen generation module 404 generates an image to be displayed on the display device of the display terminal 40 on the basis of the vehicle image information and the parking position information acquired by the acquisition module 403. The screen control module 405 outputs the image generated by the screen generation module 404 to the display device of the display terminal 40 (Step S115).

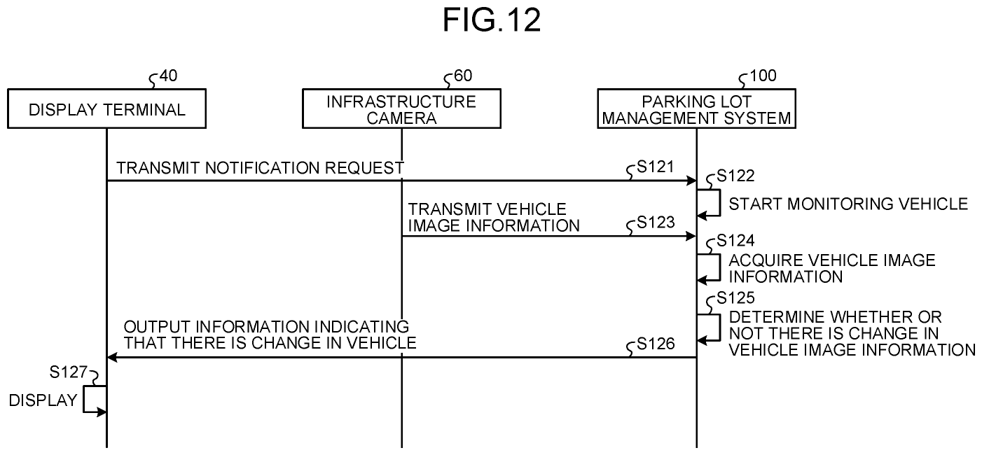

Next, a procedure of processing executed in the information providing system 10 will be described below with reference to FIG. 12. FIG. 12 is a sequence diagram illustrating an example of a procedure of processing executed in the information providing system 10 according to the present embodiment. In a state immediately before the sequence illustrated in FIG. 12 is executed, it is assumed that the parking lot management system 100 performs the user registration 41 and the vehicle is parked in the parking section.

The communication module 401 transmits the notification request 441 input by the user to the parking lot management system 100 (Step S121). The monitoring module 209 starts monitoring the vehicle on the basis of the notification request 441 transmitted from the display terminal 40 (Step S122). The infrastructure camera 60 transmits the captured vehicle image information to the parking lot management system 100 (Step S123). The monitoring module 209 acquires the vehicle image information transmitted by the infrastructure camera 60 (Step S124). The monitoring module 209 determines whether or not there is a temporal change in the acquired vehicle image information (Step S125).

When the monitoring module 209 determines that there is a temporal change in the vehicle, the output module 208 outputs the vehicle image information to the display terminal 40 (Step S126). The acquisition module 403 acquires the vehicle image information output from the output module 208. The screen generation module 404 generates an image to be displayed on the display device of the display terminal 40 on the basis of the vehicle image information acquired by the acquisition module 403. The screen control module 405 outputs the image generated by the screen generation module 404 to the display device of the display terminal 40 (Step S127).

As described above, in the information providing method according to one aspect of the present disclosure, when a request, from the display terminal 40 of the user, for the image of the vehicle of the user and the parking position of the vehicle is accepted, vehicle image information associated with the user information 410 registered by the user is acquired from the vehicle image information, and the parking position of the vehicle is specified on the basis of the acquired vehicle image information, so that the image of the vehicle of the user and the parking position of the vehicle are displayed on the display terminal 40 of the user.

As a result, according to the present embodiment, by checking an image of a parked vehicle, a state of the vehicle can be checked at any timing at which the user wants to check the state. For example, a user can check, on the display terminal 40, that the user has forgotten turning off an interior lamp of the vehicle or has forgotten locking the vehicle. A user can monitor a vehicle with a simple operation.

### Modification Example

Next, a modification example will be described with reference to the drawings. Description of parts common to the above-described embodiment will be omitted as appropriate. Note that constituent elements similar to those in the above-described embodiment are denoted by the same reference numerals, and description thereof will be omitted as appropriate.

In the above-described embodiment, a mode has been described in which the specifying module 205 specifies the parked vehicle information including the user information 410 and the vehicle information 414 accepted by the acceptance module 204 from among the pieces of parked vehicle information stored in the storage unit 207, and specifies, from the specified parked vehicle information, the vehicle used by the user from whom the request has been accepted and the parking position information. In the modification example, for example, a mode in which an entrance camera is provided to specify a vehicle and a parking position specified by the specifying module 205 will be described.

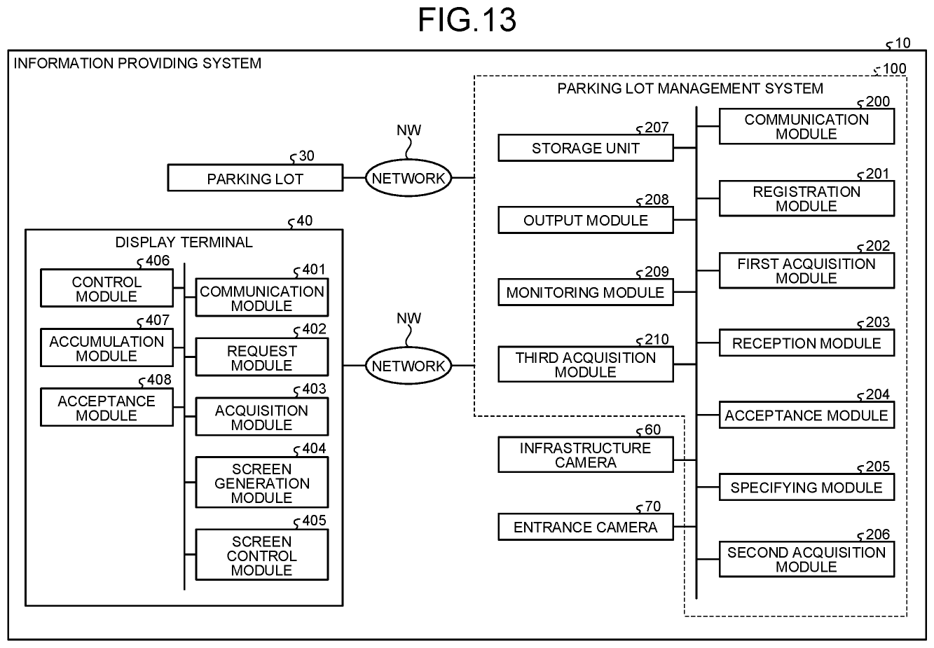

FIG. 13 is a block diagram illustrating an example of functions provided in an information providing system 10 according to a modification example. The information providing system 10 includes a display terminal 40, a parking lot management system 100, an infrastructure camera 60, and an entrance camera 70. In the information providing system 10, the display terminal 40, the parking lot management system 100, the infrastructure camera 60, and the entrance camera 70 communicate with each other via a communication network.

The entrance camera 70 is a sensor that observes a vehicle entering the parking lot. For example, the entrance camera 70 captures an image of a number plate of the vehicle entering the parking lot, and acquires number plate data. The entrance camera 70 captures an image of the entire vehicle or a color that allows ascertaining of the vehicle together with the number plate of the vehicle. The entrance camera 70 is installed near a gate of a parking entrance in the parking lot, and an installation place and an angle of view are adjusted in advance so that a number plate can be imaged. A management number is assigned to the entrance camera 70.

As illustrated in FIG. 13, the parking lot management system 100 according to the modification example includes a registration module 201, a first acquisition module 202, a reception module 203, an acceptance module 204, a specifying module 205, a second acquisition module 206, a storage unit 207, an output module 208, a monitoring module 209, and a third acquisition module 210. A function of the parking lot management system 100 is not limited thereto.

The third acquisition module 210 acquires parking entrance information indicating information that is information indicating that the vehicle has entered the parking lot. Specifically, the third acquisition module 210 acquires, from the entrance camera 70, the vehicle image captured by the entrance camera 70 and the management number of the entrance camera 70. The third acquisition module 210 specifies the entered vehicle from the number plate included in the vehicle image. The third acquisition module 210 can ascertain the vehicle that has entered the parking lot by acquiring the number plate imaged by the entrance camera 70.

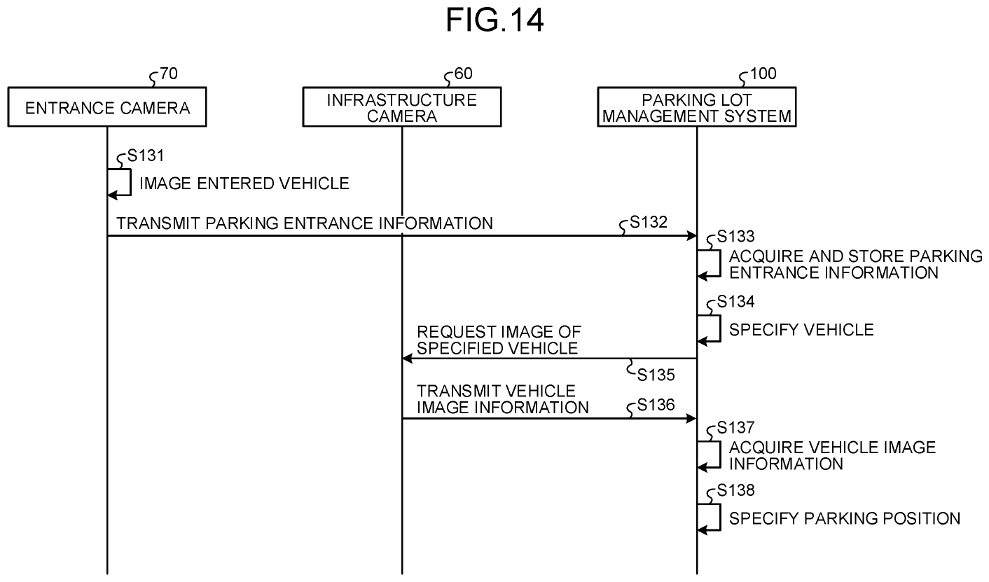

Next, a procedure of processing executed in the information providing system 10 will be described below with reference to FIG. 14. FIG. 14 is a sequence diagram illustrating an example of a procedure of processing executed in the information providing system 10 according to the modification example. A state immediately before the sequence illustrated in FIG. 14 is executed will be described as a state in which the parking lot management system 100 has performed the user registration 41.

The entrance camera 70 images a vehicle that has entered the parking lot (Step S131). The entrance camera 70 transmits imaged parking entrance information to the parking lot management system 100 (Step S132).

The third acquisition module 210 acquires the parking entrance information imaged by the entrance camera 70 transmitted in Step S132 (Step S133). The third acquisition module 210 stores the acquired parking entrance information in the storage unit 207. The third acquisition module 210 acquires the number plate from the parking entrance information. The specifying module 205 specifies the vehicle on the basis of the vehicle information 414 registered by the registration module 201 and the number plate acquired by the third acquisition module 210 (Step S134).

The first acquisition module 202 requests an image of the vehicle specified by the specifying module 205 from the infrastructure camera 60 (Step S135). The infrastructure camera 60 transmits the vehicle image information to the parking lot management system 100 on the basis of the request from the first acquisition module 202 (Step S136). The first acquisition module 202 acquires the vehicle image information transmitted by the infrastructure camera 60 (Step S137). The specifying module 205 specifies a parking position where the vehicle is parked from the vehicle image information acquired by the first acquisition module 202 (Step S138).

As described above, in the information providing method according to one aspect of the modification example, when a vehicle enters the parking lot 30, parking entrance information indicating information that the vehicle has entered the parking lot 30 is acquired, and a parking position of the vehicle is specified from vehicle image information on the basis of the acquired parking entrance information, so that an image of the vehicle of the user and the parking position of the vehicle are displayed on the display terminal 40 of the user. As a result, the vehicle used by the user can be specified, and the image of the vehicle and the parking position of the vehicle can be displayed on the display terminal 40 of the user.

According to the information providing method according to one aspect of the present disclosure, a state of a vehicle can be checked according to an operation of a user.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information providing method in a parking lot management system that communicates with display terminals of users and manages vehicle image information including images of vehicles parked in parking sections of a parking lot, the information providing method comprising:
when a request, from a display terminal of a user among the users, for an image of a vehicle of the user and a parking position of the vehicle is accepted, acquiring, from the vehicle image information, vehicle image information associated with user information registered by the user; and
specifying the parking position of the vehicle based on the acquired vehicle image information to cause the display terminal of the user to display the image of the vehicle of the user and the parking position of the vehicle.

2. The information providing method according to claim 1, further comprising
when there is a temporal change in the vehicle image information, causing the display terminal of the user to display the image of the vehicle of the user and the parking position of the vehicle.

3. The information providing method according to claim 1, further comprising
causing the display terminal of the user to display an image of an adjacent vehicle that indicates a vehicle adjacent to the vehicle and is included in the vehicle image information.

4. The information providing method according to claim 2, further comprising
causing the display terminal of the user to display an image of an adjacent vehicle that indicates a vehicle adjacent to the vehicle and is included in the vehicle image information.

5. The information providing method according to claim 1, further comprising
causing the display terminal of the user to display a parking section position where the vehicle is parked and imaging device information indicating an imaging device that images the parking section position, the parking section position and the imaging device information being included in the vehicle image information.

6. The information providing method according to claim 2, further comprising
causing the display terminal of the user to display a parking section position where the vehicle is parked and imaging device information indicating an imaging device that images the parking section position, the parking section position and the imaging device information being included in the vehicle image information.

7. The information providing method according to claim 3, further comprising
causing the display terminal of the user to display a parking section position where the vehicle is parked and imaging device information indicating an imaging device that images the parking section position, the parking section position and the imaging device information being included in the vehicle image information.

8. The information providing method according to claim 1, further comprising
causing the display terminal of the user to display registration number information indicating a registration number of the vehicle, vehicle type information indicating a vehicle type of the vehicle, and color information indicating a color of the vehicle, the registration number information, the vehicle type information, and the color information being included in the user information.

9. The information providing method according to claim 2, further comprising
causing the display terminal of the user to display registration number information indicating a registration number of the vehicle, vehicle type information indicating a vehicle type of the vehicle, and color information indicating a color of the vehicle, the registration number information, the vehicle type information, and the color information being included in the user information.

10. The information providing method according to claim 3, further comprising
causing the display terminal of the user to display registration number information indicating a registration number of the vehicle, vehicle type information indicating a vehicle type of the vehicle, and color information indicating a color of the vehicle, the registration number information, the vehicle type information, and the color information being included in the user information.

11. The information providing method according to claim 5, further comprising
causing the display terminal of the user to display registration number information indicating a registration number of the vehicle, vehicle type information indicating a vehicle type of the vehicle, and color information indicating a color of the vehicle, the registration number information, the vehicle type information, and the color information being included in the user information.

12. The information providing method according to claim 1, further comprising:
acquiring, when the vehicle has entered the parking lot, parking entrance information indicating that the vehicle has entered the parking lot; and
specifying the parking position of the vehicle from the vehicle image information based on the acquired parking entrance information to cause the display terminal of the user to display the image of the vehicle of the user and the parking position of the vehicle.

13. The information providing method according to claim 2, further comprising:
acquiring, when the vehicle has entered the parking lot, parking entrance information indicating that the vehicle has entered the parking lot; and
specifying the parking position of the vehicle from the vehicle image information based on the acquired parking entrance information to cause the display terminal of the user to display the image of the vehicle of the user and the parking position of the vehicle.

14. The information providing method according to claim 3, further comprising:
acquiring, when the vehicle has entered the parking lot, parking entrance information indicating that the vehicle has entered the parking lot; and
specifying the parking position of the vehicle from the vehicle image information based on the acquired parking entrance information to cause the display terminal of the user to display the image of the vehicle of the user and the parking position of the vehicle.

15. The information providing method according to claim 5, further comprising:
acquiring, when the vehicle has entered the parking lot, parking entrance information indicating that the vehicle has entered the parking lot; and
specifying the parking position of the vehicle from the vehicle image information based on the acquired parking entrance information to cause the display terminal of the user to display the image of the vehicle of the user and the parking position of the vehicle.

16. The information providing method according to claim 8, further comprising:
acquiring, when the vehicle has entered the parking lot, parking entrance information indicating that the vehicle has entered the parking lot; and
specifying the parking position of the vehicle from the vehicle image information based on the acquired parking entrance information to cause the display terminal of the user to display the image of the vehicle of the user and the parking position of the vehicle.

17. A computer program product including programmed instructions embodied in and stored on a non-transitory computer readable medium, wherein the instructions, when executed by a computer of a display terminal including a display, the display terminal being connectable, via a network, to a parking lot management system that manages vehicle image information including images of vehicles parked in parking sections of a parking lot, cause the computer to perform:
requesting the parking lot management system to transmit vehicle image information associated with user information of a user who owns the display terminal and a parking position of a vehicle of the user; and
causing the display of the display terminal to display an image of the vehicle of the user and the parking position of the vehicle included in the vehicle image information received from the parking lot management system.
